(19) United States
(12) Patent Application Publication
(10) Pub. No.: US 2013/0299272 A1
(43) Pub. Date: Nov. 14, 2013

(54) Door Closing Noise Attenuator Releasably Attachable To Door Knobs

(71) Applicants: Gwen Williams, Riverside, CA (US); Lyndsey Gaskins, Corona, CA (US)

(72) Inventors: Gwen Williams, Riverside, CA (US); Lyndsey Gaskins, Corona, CA (US)

(21) Appl. No.: 13/470,331

(22) Filed: May 13, 2012

(51) Int. Cl. F16F 15/00

(52) U.S. Cl. 181/209

(57) ABSTRACT

A noise attenuator for reducing clicking and slamming noises produced by the closing of a door includes a thin elongated rectangularly-shaped flexible, resiliently deformable padding member having D-shaped elastic strap loops protruding from opposite short vertical edges of the padding member. One of the strap loops is stretched to fit over a first door knob to thereby hang the attenuator from a first door knob preparatory to use. The padding member is pivoted to a horizontal use position over the door latch and the second loop stretched to fit over the second door knob. When the door is closed, the padding member prevents contact between metal parts of the door and door casing latching mechanism and prevents slamming contact between the door and members in the door casing.

### BACKGROUND OF THE INVENTION

A. Field of the Invention

The present invention relates to articles useable to reduce annoying noises in structures occupied by people. More particularly, the invention relates to a portable noise attenuator accessory which is releasably attachable to a pair of back-to-back door knobs of a door and is effective in substantially attenuating sounds typically produced by a closing door.

B. Description of Background Art

Most doors used in entrances to rooms in homes, offices and other such structures used by people have a relatively standardized form factor and construction, Such doors typically have the shape of a vertically elongated, rectangular wooden or composite slab which has on an inner vertical edge face thereof a column of vertically spaced apart door-mounted hinge halves. The door-mounted hinge halves are pivotably coupled to complementary door casing hinge halves which are mounted to a door casing. The door casing has a shape similar to that of the door outline, and is slightly larger, so that the door can swing freely on the hinges from an open or ajar position, to a position in which the door rests congruently within the opening of the casing. Usually, closing motion of the door within the casing is limited by a stop consisting of thin molding strips which form an inverted U-shaped ridge which protrudes into the door casing opening from upper and side edges of the casing opening.

Swinging doors of the type described above typically include a pair of axially aligned inner and outer door knobs, and a latching mechanism which is unlatched by turning either door knob. The latching mechanism typically includes a uniform cross-section latch bolt which has a beveled or ramped outer surface, and is reciprocally through an aperture through a latch plate mounted on an outer edge of the door. The latch is biased to an outwardly plate or striker mounted on an inner facing surface of the door casing, the latch bolt is depressed inwardly into the latch plate aperture against a resilient force provided by the spring within the latch mechanism. When the door is swung further to a fully closed position and seated against the stop molding strips within the door casing, the latch spring urges the latch bolt outwards into a mortise recess in the casing-mounted striker plate, thus latching the door in a closed position.

A door is unlatched to enable it to be swung to an open position by twisting the inner or outer door knob, both of which are coupled to the latch bolt by a rotary-to-linear actuator mechanism, thus withdrawing the latch bolt from the striker plate mortise and thereby enabling the door to be swung to an open position.

Swinging doors of the type described above, however well made, usually emit relatively loud sounds when closing. Metallic clicking sounds are produced by the initial contact of a latch bolt with a casing-mounted striker plate, and again when the latch bolt springs into the striker plate recess or aperture. Slamming or banging sounds are produced by forcible impact of a closing door against the stop moldings within the door casing.

Sometimes, the clicking and slamming noises produced by a closing door can disrupt a person's sleep or train of thought, or otherwise be mildly annoying. However, the noises can cause bigger problems, as for example, when closing a door to a room in which a mother has just placed her sleeping baby. Consequently, it would be desirable to make available an article which could reduce or attenuate noises typically produced by closing doors, and that desirability motivated the present inventors to conceptualize and produce the door closing noise attenuator disclosed herein.

### OBJECTS OF THE INVENTION

An object of the present invention is to provide a door closing noise attenuator which is releasably attachable to a door knob.

Another object of the invention is to provide a door closing noise attenuator which is releasably attachable to a pair of inner and outer door knobs of a door and is effective in eliminating clicking noises typically produced when closing the door, and substantially reducing noises produced by slamming a door against stop members of a door casing.

Another object of the invention is to provide a door closing noise attenuator which is releasably attachable to a pair of door knobs of a door, and which maintains a door tightly shut without requiring a latch bolt of the door to engage a striker plate of the door casing

Various other objects and advantages of the present invention, and its most novel features, will become apparent to those skilled in the art by perusing the accompanying specification, drawings and claims.

It is to be understood that although the invention disclosed herein is fully capable of achieving the objects and providing the advantages described, the characteristics of the invention described herein are merely illustrative of the preferred embodiments. Accordingly, we do not intend that the scope of our exclusive rights and privileges in the invention be limited to details of the embodiments described. We do intend that equivalents, adaptations and modifications of the invention reasonably inferable from the description contained herein be included within the scope of the invention as defined by the appended claims.

### SUMMARY OF THE INVENTION

Briefly stated, the present invention comprehends a door closing noise attenuator which is releasably attachable to a pair of door knobs of a door, and is effective in substantially reducing sounds produced when the door is closed.

A door closing noise attenuator according to the present invention includes a thin, laterally elongated, rectangularly-shaped flexible body which has protruding laterally outwards from opposite short vertical sides thereof left and right elastically stretchable attachment straps, which have generally the shape of D-ring loops. The rectangular body of the noise attenuator is preferably made of a soft, resiliently compressible material, such as a relatively thick woven fabric. In a preferred embodiment, the body of the noise attenuator by sewn stitches arranged in an outer concentric ring. Preferably, the body of the noise attenuator has a central rectangular shaped section which is made thicker than peripheral edges of the body by a rectangular insert or pad made of a soft, resilient material such as cotton batting. The insert is secured within the body of the noise attenuator by a second, inner rectangular ring-shaped sewn stitch ring which is located concentrically within the outer stitch ring.

According to the invention, the elastic loop protruding outwards from one side of the noise attenuator body is stretched to fit over a first, e.g., inner door knob, and suspended from the axle shaft of the door knob until the noise attenuator is to be used. At that time, the body of the attenuator is pivoted upwards on the first door knob shaft to a horizontal position, and flexed forward around the latch bolt face plate of the door, whereupon the second elastic loop is stretched over the second, e.g., outer, door knob.

With the first and second attachment loops of the attenuator thus secured to inner and outer door knobs, the body of the attenuator covers the latch bolt face plate and latch bolt, thus preventing contact of the latch bolt and latch plate with the striker plate mounted in the door casing, and thereby preventing generation of clicking sounds when the door is closed. Moreover, that part of the padded attenuator body which extends around the closing edge of the door abuts the door stop molding when the door is closed abruptly. The padded area of the attenuator on the outer face of the door prevents the door from making contact with the stop, thus preventing production of a slamming sound which could otherwise result from direct contact between hard surfaces of the door and stop. Also, the resilience of the padding within the body of the attenuator causes a substantially large frictional force to be exerted between the door and striker plate region of the door casing, thus securing the door in place without requiring engagement of the striker plate by the now-covered latch bolt.

### BRIEF DESCRIPTION OF THE DRAWINGS

FIG. 1 is an upper plan view of a door closing noise attenuator releasably attachable to door knobs according to the present invention.

FIG. 2 is a lower plan view of the attenuator of FIG. 1.

FIG. 3 is a partly broken away view of the attenuator of FIG. 1 showing an insert pad thereof.

FIG. 4 is a view showing the noise attenuator of FIG. 1 suspended from the shaft of a first, inner door knob located on the inner side of an inward opening door.

FIG. 5 is an edge view of the door and attenuator of FIG. 4, showing the door latch plate and latch bolt.

FIG. 6 is an elevation view of the striker plate set in the casing of the door.

FIG. 7 is a view showing the attenuator of FIG. 4 swung upwardly to a horizontal orientation and bent outwardly over the latch plate and latch bolt of the door, and looped over the outer door knob of the door to thus secure the attenuator to the door in a sound-attenuating configuration.

FIG. 8 is an inner view of the door of FIG. 6 in a closed, sound attenuating configuration.

FIG. 9 is an outer view of the door of FIG. 6 in a closed, sound attenuating configuration.

### DESCRIPTION OF THE PREFERRED EMBODIMENT

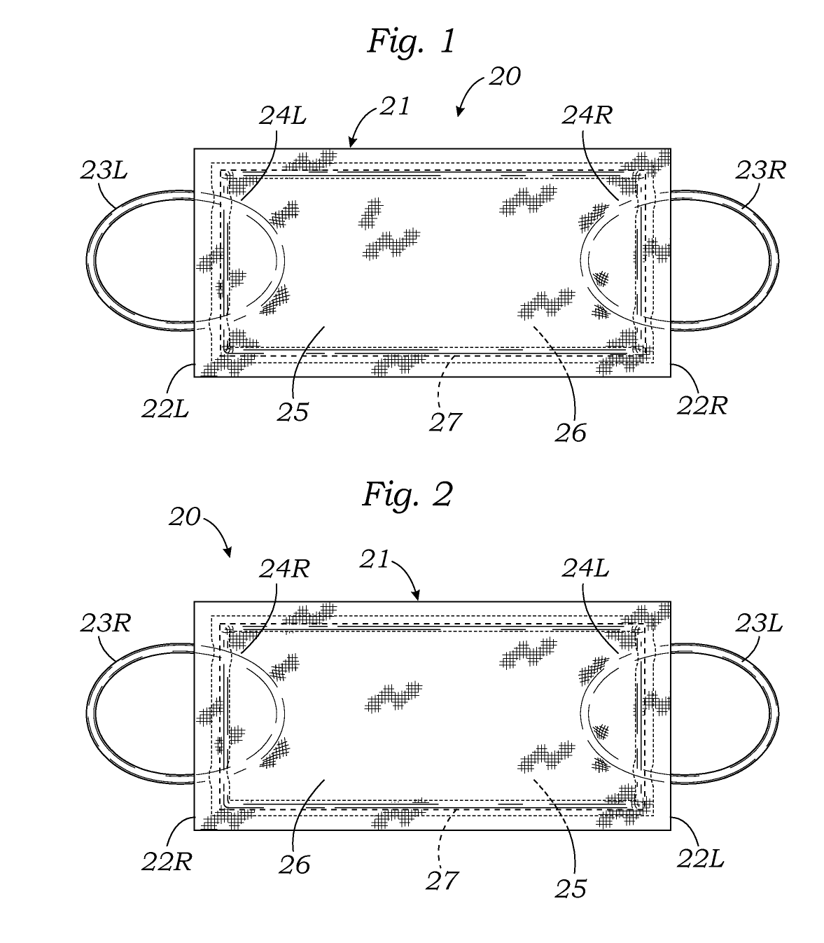

Referring now to FIGS. 1-3, a door closing noise attenuator 20 according to the present invention may be seen to include thin, laterally elongated rectangularly-shaped flexible padding member 21. Padding member 21 has protruding laterally outwards from left and right vertically disposed edges 22L, 22R thereof left and right elastically stretchable attachment strap loops 23L, 23R. Preferably, the protruding part of each strap loop 23 has generally the shape of a semi-circular “D-ring.” Optionally and preferably, each elastically stretchable attachment strap may consist of a continuous, endless circular loop made of an elastic cord, with an outwardly protruding semi-circular half of the circular loop comprising a D-ring-shaped semi-circular attachment strap loop 23, and an inner semi-circular half 24 of the circular loop secured within rectangular padding member 21, in a manner which is described below.

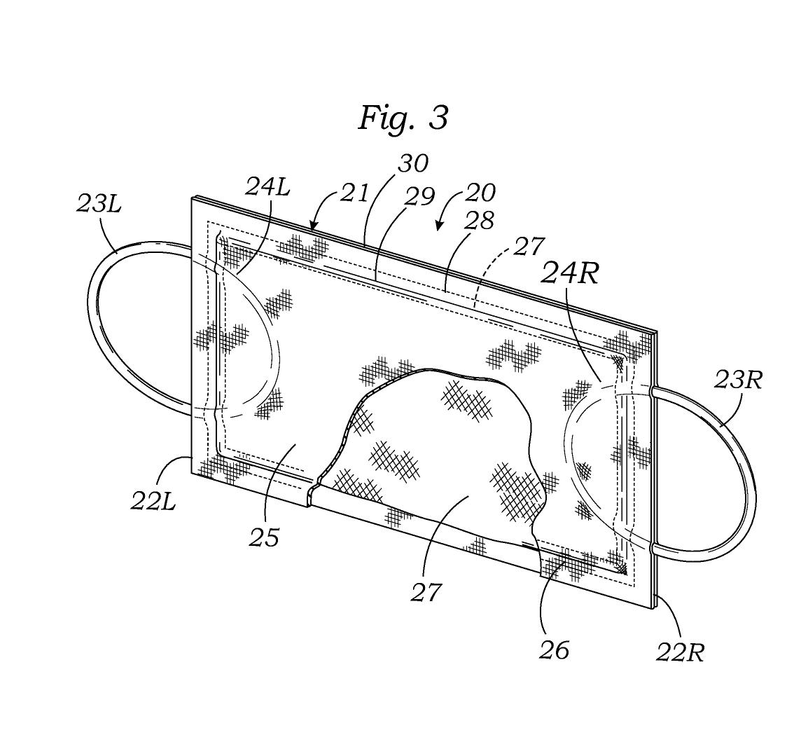

Referring to FIGS. 2 and 3 in addition to FIG. 1, it may be seen that padding member 21 of noise attenuator 20 is preferably has a laminated construction which includes a lower outer rectangular fabric panel 25, an upper, outer rectangular panel 26, and a rectangularly-shaped resilient pad 27 sandwiched between the outer fabric panels. In an example embodiment of the attenuator 20, outer fabric panels 25 and 26 were each made of 100 percent cotton plain weave fabric having a thread count of 68×68 and an area density of 3.3 oz. per square yard. Resilient pad 27 was made of batting composed of 87.5 percent natural cotton and 12.5 percent polypropylene, having a thickness of 0.125 inch and a density of 0.4 oz. per square yard.

As shown in FIGS. 1-3, outer fabric panels 25 and 26 are fastened together to thus secure pad 27 between the outer panels to form a laminated structure, and to secure inner halves 24L, 24R of the strap loops 23L, 23R to the fabric panels, by one or more rectangular rings of sewn stitches 28, 29 which are concentric with and located a short distance inwardly of the outer peripheral edge 30 of attenuator 20.

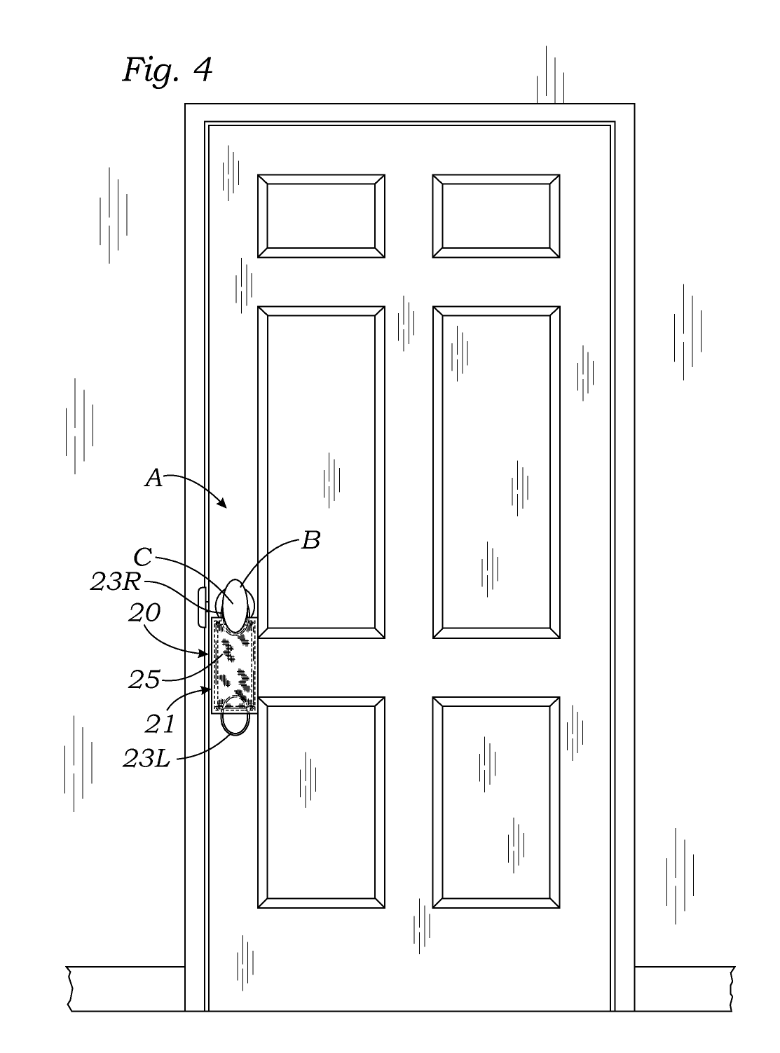

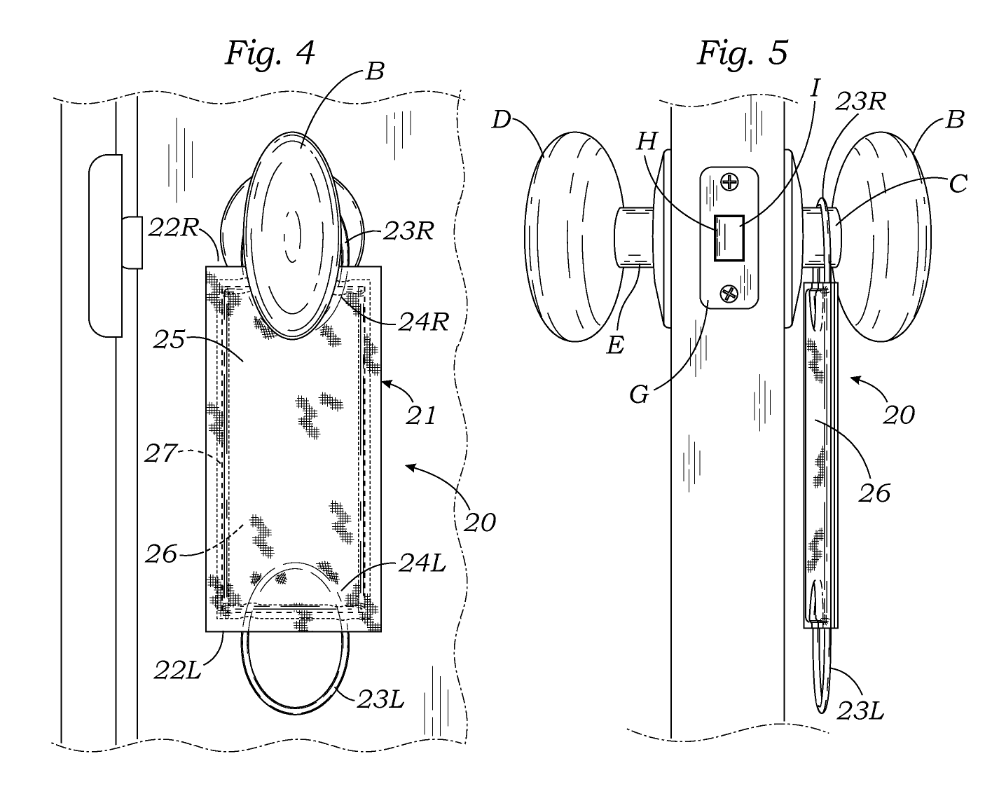

FIGS. 4-7 illustrate how noise attenuator 20 is used. First, as shown in FIG. 4, one of the elastic strap loops, for example strap loop 23R, is stretched to fit over a first door knob, for example, the inner door knob B of a door A, and looped over shaft C of the door knob. In this position, the attenuator 20 hangs from the shaft C of door knob B, preparatory to using the attenuator.

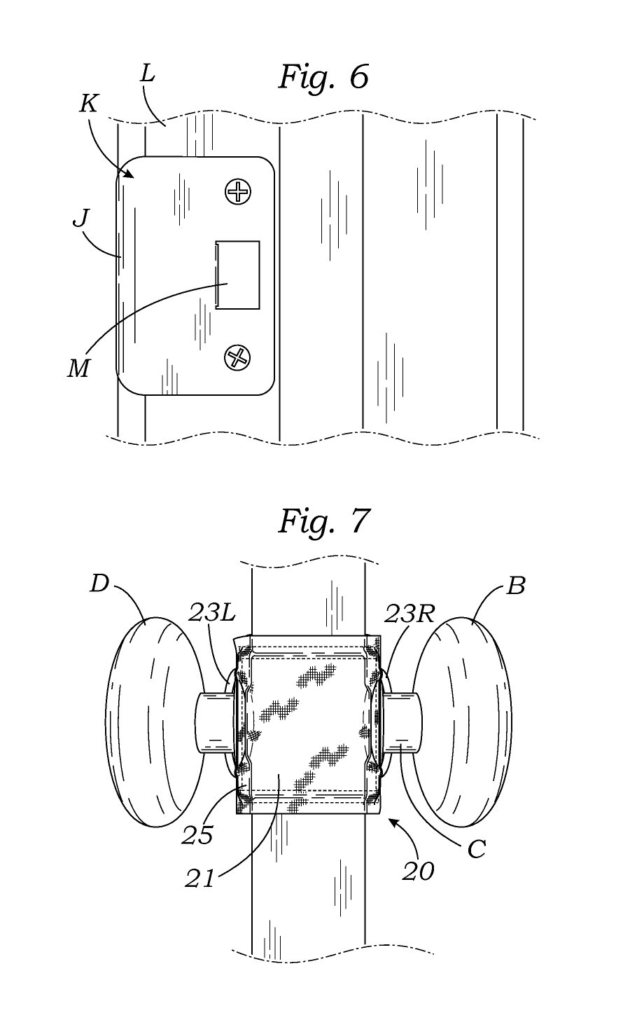

As shown in FIG. 5, door A includes a second, e.g., outer door knob D which has a shaft E longitudinally aligned with and coupled to shaft C of inner door knob B. As shown in FIG. 5, door A has inset into an edge face F thereof a latch mechanism which includes a latch plate G and a latch bolt H. Latch bolt H has a wedge shape including an outer inclined plane surface or ramp I. The latch bolt H is biased by a spring to a position protruding outwardly from latch plate G. When inclined plane surface I of the latch bolt H contacts the ramped surface J of a striker plate K mounted in a casing L which hingedly holds door A (see FIG. 6), the latch bolt H is urged forward by the spring within the latch mechanism, and lodges in the rectangular recess or mortise M in the striker plate K, with an accompanying metallic clicking sound.

As shown in FIG. 7, the noise attenuator 20 is deployed from its hanging rest position, shown in FIG. 4, to a noise attenuating use position, as shown in FIG. 7, by pivoting the attenuator upwards to a horizontal position and then flexing the padding member body 21 of the attenuator forward around the latch mechanism of door A. The strap loop 23L is then looped over shaft E of the outer door knob D to thus secure the attenuator to the door. With the first and second end loops 23R, 23L of the attenuator thus secured to the two door knobs B, D, the body 21 of the attenuator covers the latch bolt face plate G and latch bolt H, thus preventing contact of the latch bolt or latch plate with the striker plate mounted in the door casing, when the door is closed, and thereby preventing generation of clicking sounds when the door is closed.

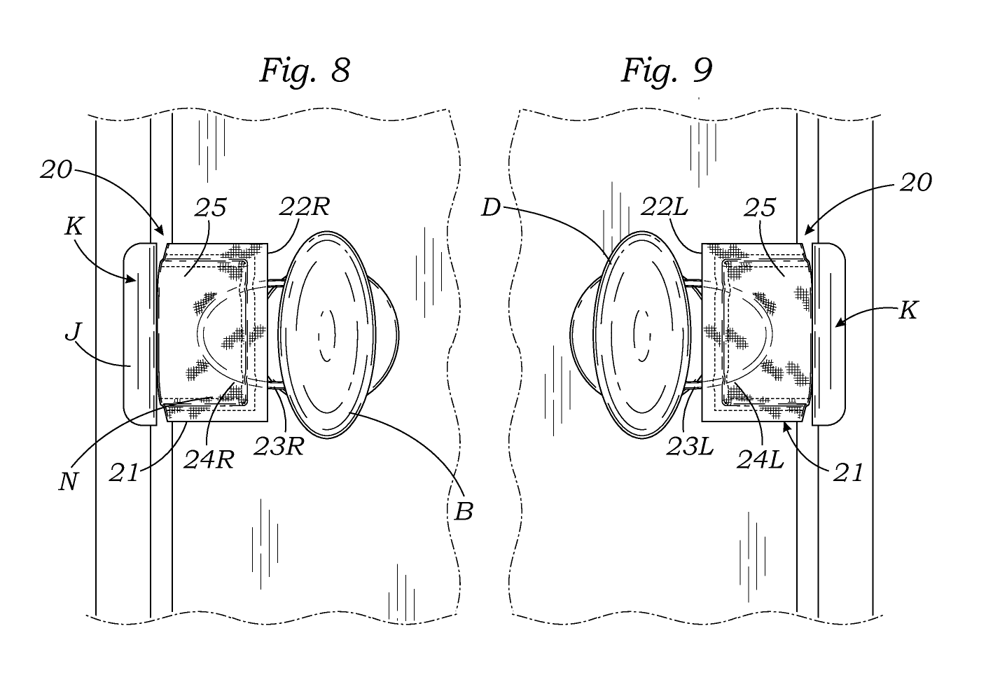

Moreover, as shown in FIGS. 8 and 9, that part of the padded attenuator body 21 which extends around the closing edge of the door abuts the door stop molding N when the door is closed abruptly. The padded area of the attenuator on the outer face of the door prevents the door from making contact with the stop, thus preventing production of a slamming sound which could otherwise result from direct contact between hard surfaces of the door A and stop N. Also, the resilience of the pad 27 within the body 21 of the attenuator 20 causes a substantially large frictional force to be exerted between the door and striker plate region of the door casing, thus securing the door in place without requiring engagement of the striker plate by the now covered latch bolt.

What is claimed is:

1. A noise attenuator for reducing noises produced by a closing door, said attenuator comprising;
a. an elongated flexible, resiliently deformable padding member,
b. at least a first fastener protruding from said flexible padding member for fastening said attenuator to a door knob, and
c. said flexible padding member being extendible from said door knob over a latching member located in an edge of a door proximate said door knob, whereby said door may be closed to resiliently compress said padding member between said latch and a casing hingedly supporting said door to prevent mutual contact of noise producing members of said door and said door casing.

2. The attenuator of claim 1 further including a second fastener attached to said padding member at a location opposite to that of said first fastener, said second fastener being attachable to a second door knob on an opposite side of a door to thereby maintain said padding member overlying said latching mechanism of said door.

3. The attenuator of claim 2 wherein said padding member includes first and second flat outer panels laminated together.

4. The attenuator of claim 3 further including a resilient pad located between inner facing surfaces of said first and second outer panels.

5. The attenuator of claim 4 wherein at least one of said first and second fasteners is further defined as being an elastically stretchable strap loop which has an unstretched inner diameter smaller than that of a door knob which said attenuator is intended to be used with.

6. The attenuator of claim 5 wherein each of said fasteners is further defined as being an endless elastic cord loop which has an inner side secured to said padding member and an outer side which protrudes outwardly of said padding member.

7. The attenuator of claim 6 wherein said inner side of said loop is secured between inner facing surfaces of said first and second outer panels.

8. The attenuator of claim 7 wherein said first and second outer panels are fastened together by sewn stitching arranged in a loop concentric with the perimeter of said outer panels.

9. The attenuator of claim 8 wherein said sewn stitching includes a first, outer loop proximate to and concentric with the outer peripheral edge of said padding member.

10. The attenuator of claim 9 further includes a second, inner stitched loop concentric with said first stitched loop.
